(19) United States
(12) Patent Application Publication
(10) Pub. No.: US 2011/0112881 A1
(43) Pub. Date: May 12, 2011

(54) SYSTEM AND METHOD FOR USER ENGAGEMENT IN TO-DO LIST TASK MANAGEMENT

(76) Inventors: HARSHITA MALHOTRA, Irving, TX (US); Rajita Singh, Irving, TX (US); Satnam Singh, Irving, TX (US); Gurmeet Singh, Irving, TX (US)

(21) Appl. No.: 12/944,199

(22) Filed: Nov. 11, 2010

Related U.S. Application Data
(60) Provisional application No. 61/260,257, filed on Nov. 11, 2009.

(51) Int. Cl. G06Q 10/00

(52) U.S. Cl. 705/7.21

(57) ABSTRACT

A system and method for helping users perform and manage actions on their to-do lists tasks by making it fun, rewarding and engaging. The system and method will help users make the task of performing and managing to-do lists tasks fun by providing tools, rewards and incentives for the user, encouraging them in a socially connected way to do the tasks. The present invention further embodies a Recognition Factor for rewarding users who complete tasks in accordance with the Offer Database and Rewards Engine, and further includes a Content Database for associating media to a to-do-list task.

### CROSS-REFERENCE TO RELATED APPLICATIONS

This application claims priority to the following related applications and included here is as a reference.

Provisional Application: U.S. Patent Application No. 61/244,926 filed Sep. 23, 2009, and entitled “SYSTEM AND METHOD FOR INTERACTIVELY CONNECTING PROVIDERS TO USER'S INDIVIDUAL OR AGGREGATED TO DO-LISTS.”

Provisional Application: U.S. Patent Application No. 61/260,257 filed Nov. 11, 2009, and entitled “SYSTEM AND METHOD FOR USER ENGAGEMENT IN TO-DO LIST TASK MANAGEMENT.”

Non Provisional Application: U.S. patent application Ser. No. 12/889,177 filed Sep. 23, 2010, and entitled “SYSTEM AND METHOD FOR INTERACTIVELY CONNECTING USERS AND THIRD PARTY PROVIDERS TO INDIVIDUAL OR AGGREGATED TO-DO LIST TASK ITEMS OF USERS WITHIN THE TASK MANAGEMENT SYSTEM”

### TECHNICAL FIELD

The present invention relates generally to an electronic task management system and method, and more particularly, to an electronic system and method for creating user engagement through rewards from the task management system, other users of the task management system, groups and third party providers. Thus encouraging users to take action and engage in a socially connected way through the electronic task management system.

### REFERENCES CITED

U.S. Patent Documents

| | | |
|---|---|---|
| Van Luchene; Sep. 20, | Celebrity Voices In A Video | US 11/693,543 |
| 2007 | Game | |
| Gilley; Mar. 27, 2008 | Rewards System | US 11/729,170 |

Applicant references the above patents for inclusion in the examiner's analysis of the system and method presented herein or reference, the present invention is distinguishable from US Patent Application No. 2008/0077489, Gilley (the “'489 application”) in that the '489 application requires user accounts to be linked with predetermined activity, distribution upon competition, and a commercial store. The present invention has no requirement for predetermined activity and, further, there is no linking of accounts from one user to another, as required by the '489 application.

### BACKGROUND OF THE INVENTION

A lot of tools exist in the market today for the user to enter, organize and manage their to-do lists tasks within their calendars. Even with all the available tools such as Microsoft Outlook, Post-It notes, diaries, automated lists, etc., it is still very problematic to take action and get things done timely and effective manner. Managing the to-do list becomes the biggest task in itself given the performance of a user to-do list task item through completion often involves multiple parties, including the following: i) the individual, group, or business initiating the to-do list task item; ii) the individual, group, or business required to perform and complete the to-do list task item; and iii) the individual, group, or business willing and able to provide help, services or products for completing the to-do list task item. Without sufficient support and incentives, the user loses interest in his or her to-do list task item and, ultimately, is unable to complete the to-do list task item.

Notwithstanding the foregoing, there are at least five (5) limitations to the current services that exist today in the market place: i) users do not remember their to-do list task items because they lack a reminder at the right time and at the right place at the right device; ii) users are unable to accomplish such to-do list task items because no one is pushing them, reminding them, or asking/tasking them in a socially connected way, and the rewards for accomplishing such to-do list task items are either deminimis or are not often associated or poorly associated with the completion of a to-do list task items; iii) managing a to-do list is boring, and not interactive or collaborative; iv) there is an overload of information and communication hitting the user via multiple channels and creating confusion regarding what to-do list task items are to be performed; and v) third parties are unable to assist the user because there is no ability to share and/or match user to-do list task items with companies or individuals that can assist in completing the to-do list task items.

The present invention seeks to address the above issues by facilitating the interaction of a user with to-do list task items, with those who can influence the user to take action and those that stand to benefit from the performance of the to-do list task items. For example, the present invention provides offers from third party providers, as to-do list task items with associated rewards, for inclusion by user in their to-do list task items along with reminders that are contextual to the list of their current to-do list task items. Others users can add to-do list task items on a user's to-do list calendar and remind the user to accomplish the task in a “socially connected” way. Further, individual, group, or business can attach incentives or “rewards” to encourage completion of a to-do list task item. These individual, group or business can make completing a to-do list task item interactive, and encourage the timely completion of such to-do list task item. Reward criteria may consist of digital media, points, coupons, and message information, such reward criteria stored within said Reward Database for use by user within the task management system, such reward criteria initially stored in the Offer Database. Upon verification of completion of to-do list task item between a user and a third party provider (or, optionally, a user and another user), the task management system transfers the reward criteria of the solicitation for offer from Offer Database and stores such reward criteria in the Reward Database, such stored reward criteria referentially associated with said User Account Database of said user. A user is then able to redeem such reward criteria at a later date, or contemporaneously with the task completed and reward criteria met. Further, users can designate groups within the task management system to associate and perform shared to-do list task items. Creating group to-do list task items helps users collaborate towards their mutual goal.

### SUMMARY

A system and method for helping users perform and manage actions on their to-do lists tasks by making it fun, rewarding and engaging. The system and method will help users make the task of performing and managing to-do lists tasks fun by providing tools, rewards and incentives for the user, encouraging them in a socially connected way to do the tasks. The user to-do-list may consist of, but not limited to, calendared events, appointments, tasks, purchase requests, sell requests, or other requests for assistance or information.

The system encourages users to complete their tasks in multiple ways. For example, in one embodiment the system grants reward points to the user when the user completes or marks complete a certain threshold of to-do list task items, items created by the user, in a system defined time interval (for example, the system can grant a user a system defined set of award points, such as one hundred (100) reward points, for every system defined set of tasks, such as ten (10) tasks, completed in a given periods). Period intervals can be minutes, hours, days, weeks or months. The system may then set rules for the time frame of task completion, within such time frame the user must mark the defined to-do list task items as declined, in progress or complete. The marking of the user to-do list task is recorded in the User Calendar Database. The system may not require that the to-do list task items completion be verified or tracked but rather grants rewards so long as the user marks to-do list task items complete. Actual completion of the task may or may not have occurred and, in certain instances, the system can track to-do list task item completion. The system may measure task completion against an individual item/goal or across multiple/all task items on the to-do list. These task items can be mutually exclusive, repeating, recurring, continuing, one-time event only or based on other system defined rules. For example, if to-do list task items are completed within a defined time frame across multiple users, then bonus reward points may be provided or additional to-do list task items may be created to enhance rewards and user satisfaction. For the purpose of this invention the usage and definition of reward points extends to include rewards points, incentives, awards and any such means of recognition and reward.

Users or authorized Other users and third party providers can view, listen, create, update or modify to-do list items within the User Calendar Database using an input terminal through a plurality of means such as a widget application, logging on remotely to a system account associated with the User Calendar Database, emails to said system account, and other means, such as a touch tone phone, mobile phone, mobile terminal, SMS, voice, voice mail, electronic mail, instant messaging, widget application, software application, or automated voice announcement software or voice recognition software. The User Calendar Database may connect and receive information and content from a centralized Offer Database (the “Offer Database”) that contains then current to-do-list items for incorporation into a users to-do-list in the User Calendar Database, including action details, due dates, and the number of reward points and/or other incentives (FIG. 2). Offer Database and User Calendar Database may periodically refresh based on individually defined user profiles, a user to-do list, an aggregation of all user-to-do-lists, or a partial sampling of all user to-do-list items found in the User Calendar Database, as allowed by individual user authorization in the User Profile and system administrator defined parameters.

In another embodiment the system allocates to users in the Rewards Engine an amount of system pre-defined reward points for marking complete the to-do list task items created by other users in an individual user to-do list. The system sets the amount of reward points in a similar fashion as above, but may further provide for a multiplication factor over the reward points for user created to-do list items in the User Calendar Database. This results in an increase in the reward points accumulated in the Rewards Engine. For example, user reward points are increased by a multiplication factor over the reward points for the same number of to-do list task items marked complete if such items marked complete were created by other users. Therefore, the present invention encourages users to assist others in the performance of and management of other to-do list task items.

An embodiment of this invention is the capability of users and or other users or third party providers to create “group task” items by creating common to-do list task items across multiple users. In such instances the system may allocate a pre-defined multiplication factor over the reward points within the Rewards Engine for the group task to-do list items completed. The system may grant additional reward points to all users that share the group task if the users complete or mark complete their group tasks in a certain system defined time period interval (FIG. 3). In this case the system provides an electronic dashboard of to-do-list task completion by individual users or by a group aggregation, as determined by the system administrator, to all group users, and/or other users, to encourage group task completion and receiving rewards. The system will define the parameters for awarding, within the Rewards Engine, reward points based on multiple factors, including but not limited to, number of users in the group, group history, type of task, duration of task, time to complete the task, task originator, etc.

In another instance the system and or other users or third party providers may populate the Offer Database with predefined to-do items and tasks with pre-defined allocation of reward points for use by the Rewards Engine. The users, at their discretion, can add these tasks to their to-do list and take action on the tasks to receive reward points from the system. The system will define the parameters for reward point grants based on multiple factors, including but not limited to, the user, user history, type of task, duration of task, and time to complete the task, etc. Within the Offer Database, the system can also set up task challenges for users to add to their to-do list and complete tasks to receive the reward points. The system will define the conditions/parameters that qualify tasks as complete. Once a challenge or pre-defined to-do item and task is accepted by a user, it is added to the users to-do-list within the User Calendar Database. The system can provide information, based on the user profile, to other users to let them know about the task challenges accepted by the user. The information will include but not limited to the task challenge summary, details and or progress.

The system will track task completion through a “Tracking Engine” (FIG. 5 and FIG. 6). The Tracking Engine shall receive information/pointers about user(s) to to-do list items, user(s) and group user(s) profiles, information and user(s) actions in association with the relevant Offer Database, as selected by the user.

Task actions include but are not limited to a sale, buy, form completion, visit, trial, inquiry or any user action required by the to-do list item task. These actions can be performed in the physical or virtual space

To-do list task item action information from the Offer Database and associated user/identifier is passed to the Tracking Engine for processing and analysis. The action information can be tracked through a plurality of means including but not limited to point-of-sale, kiosks, mobile terminals, data terminals, voice terminals through various methods examples of which include but are not limited to entry of a unique CIDOR id (reference: provisional patent No. 61/244,926, System and Method for Interactively Connecting Providers to User's Individual or Aggregated To-Do-Lists, Singh), code receipt and subsequent entry on a web site or calling, scan of the receipt/bar code/QR code or similar codes, RFID, mailing in a postcard/form/letter, registered credit card, registered store cards, other registered cards, data linkages or any other automatic or manual means through which an action can be tracked. The Tracking Engine passes task action status to the User Calendar Database for use with the Rewards Engine and future redemption as earned by the User.

The Rewards Engine, based on system preferences as set by a computer administrator, shall record and audit times for completions of the reward and reward points established within the Offer Database and as established by an originating user or third party provider within the individual user to-do-list items within the User Calendar Database. For example the system can define a time interval whereby incomplete tasks older than the set time interval will not qualify for reward points. The system can specify grace period for tasks. The system can provide higher reward points for tasks completed in shorter period intervals of time.

The system can also encourage users to complete to-do list items by providing digital certificates, pseudonyms, monikers, plaques, or other items of recognition for example, but not limited to, ‘Biggest accomplisher’, ‘Most accomplished’, ‘Task Generator’, ‘Task Master’, etc. (the “Recognition Factor”) The Recognition Factor can be digital or physical stamps that get associated and displayed with the User Profile, and thereafter become a part of the user identify for display on the system network to other authorized third party providers or other users as defined by the system and/or the user profile. The Recognition Factor can further be used to refine reward point allocation and the Offer Database. For example, the more accomplished the user is and the higher the Recognition Factor, then the greater the Rewards Engine allocation of reward points and the more offers available to that user through the Offer Database.

As with a lot of current systems, the system will present the user with the choices for redeeming reward points for a multitude of gifts. In another embodiment our to-do list system can include a ‘Concierge service’ for users who meet the system set criteria of reward points. In addition such a service can also be made available by our to-do list system on a fee basis for user's own use or as a gift to other users. Task Contacts can also buy/avail this service for other users as a reward, gift and/or incentive. With a ‘Concierge service’ a user shall receive personalized assistance from an individual and/or system who will assist the user in remembering and/or performing to-do-list tasks for a set number of tasks or for tasks within a set duration or both, Examples of an individual could include but is not limited to a celebrity/personality or a provider or a service professional or any other person

The system provides capabilities and the abilities for the user to pick from a central “Content Database” pictures, images, icons, sketches, recorded voices, videos, animations, sensory alerts, favorite statements/spoken words, voices/images/videos of celebrities/personalities/relatives/friends, voices etc. Users and/or Task Contacts will be able to associate such content with individual to-do-list task items within the User Calendar Database and or Offer Database. The present invention vastly expands on such features available in the market today. Current features available are limited to select/constrained set of sound alerts only, and do not differentiate based on list category, context, etc. The Content Database will contain a multitude of content choices for the user to pick from, including user uploaded, system licensed and/or impersonated, favorite spoken words of famous personalities, voices identifying a cause, animal sounds, bug sounds, character sounds/voices, etc. Task Contacts, that may include businesses, institutions, etc., can also publish sensory alerts, icons, pictures, voice, brand voice/video, video, campaign voice/video, animation etc. in the Content Database for them to be able to associate these Content Database items with the reminders related to the user's to-do list. These will also be accessible for the users to choose and utilize for their personal, non-business related reminders. The system may also use licensed samples of content e.g. photo, voice etc. from people to add to its database for users to connect and use for their to-do lists. For example, content may consist of any electronic media, such as formats consisting of JPEGS, BMPS, GIFS, TIFS, AVIS, MPEGS, MOVS, WAV, and MP3 or such other after developed formats.

The Content Databases can be created/populated/managed by either the system, vendors or users or any combination therefore. The system and/or vendor can provide access to such databases and/or differentiate access to items in such databases, to the user for free, for a fee, as an option to purchase using reward points (from the system or external reward points) and/or on achieving certain targets.

The system will also provide similar and more capabilities in a unique electronic mail service offered for the users i.e. the system will offer various audio or visual cues as alerts to inform them of the context of a new electronic message. The context includes but is not limited to message content, sender (type, characteristic), conversation thread, time of day and other plurality of factors that may be available to the system. The system may utilize such information to generate custom audio and/or visual cues to inform the user of the plurality of email context so the user may take appropriate action. An example, of which there are many, includes a scenario wherein the user may be informed that the new email is regarding information related to an action item. In another example, the system may present an animated icon or picture next to or in the subject line that is determined to be contextually relevant to the email message. An embodiment of the invention is that such an electronic mail service offered by the system will significantly or completely eliminate spam/junk electronic messages and/or provide security to the users. In another embodiment of this invention, this may also be used to significantly or completely eliminate spam/junk direct mail to the users.

Other examples of services related to making to-do lists engaging and fun for users include, but not limited to, “sermons”, quotes, jokes, quizzes, inspirational messages, etc. integrated into the user's to-do task list. The content for such services is supplied by the system, user or Task Contacts and may reside in the Content Database. Such content is presented to the user when the user interacts with the to-do list and as defined system and the user profile. The user selects this service for free or a fee as defined by the system and in the user profile. In addition that Task Contacts can pay for and/or sponsor such services for other users.

The said system and method optionally delivered through rewards and incentives encouraging users to perform tasks in a socially connected way. A user to-do list task item may consist of calendared events, appointments, tasks, solicitation for offers, or other requests for assistance or information (collectively, “solicitation for offer(s)”). A user to-do list task item may be modified by the user, an authorized third party provider (such as an advertiser, solicitor or assistor), or any institution, or any business, or service provider, or such other task management system users as the user may authorize from time to time. The third party providers may be individuals or businesses or institutions providing information, services, products, assistance or other solicitation for offers may be customers, advertisers, solicitors, assistors, or any institution, or any business, or any service provider or other task management system users.

The task management system maintains a centralized User Calendar Database (the “User Calendar Database” FIG. 1) the contents of which are customizable and definable by the task management system, a user, or an authorized third party provider by entry of to-do list task items and/or linkable solicitation for offers associated with such to-do list task items. The User Calendar Database can be automatically or manually populated, viewed, modified, listened to, or updated with information by users or third party providers using an input terminal (see generally, FIG. 1) through a plurality of means such as a web based task management system or other internet or intranet user interface, offline or online widget application, logging on remotely to a task management system user account associated with the User Calendar Database, emails to said task management system account, and other means, such as a touch tone phone, mobile phone, mobile terminal (FIG. 1A), SMS, image, video, MMS, voice, voice mail, electronic mail, instant messaging, widget application, software application, or automated voice announcement software or voice recognition software, Application Programming Interface (API), or Kiosks or Point of Sale System (POS).

The user can additionally interact with the User Calendar Database in multiple ways. Some examples, include but are not limited to, are the user's ability to mark to-do list task items as public or shared with group(s), ability to join an existing public to-do list task item and/or seek information from other users with similar public to-do list task items or utilize the size of the “joint to-do list task item” to receive better offers from third party providers.

The User Calendar Database may connect and receive information and content from a centralized Offer Database (FIG. 1) (the “Offer Database”) that contains then current advertisements, solicitations, information, content and/or offers that are populated by third party providers or the task management system. In one example, of which there are many, third party providers may periodically refresh advertisements, solicitations, information, content and/or offers based on, but not limited to, individually defined user profiles and/or user to-do list, or an aggregation of all, or partial sampling of, user to-do list task items found in the User Calendar Database.

The individual user profile associated with the User Calendar Database, as established by a task management system administrator, may be viewed, accessed, or modified according to user defined preferences and account settings stored within the User Account Database (see generally, FIG. 2), including, but not limited to, capturing user preferences for one or more means of authorizing a third party provider to communicate with said user, such means may include regular mail, express mail, phone, mobile phone, mobile terminal, voice mail, electronic mail, SMS, MMS, Kiosks, POS, instant messaging, or other form of Internet or wireless communication (collectively, the “User Profile”). A User Profile may further include group preferences of task management system users who are familial to said user, list of task management system users who are within said user's social network, list of task management system users who are non-profit business entities, list of task management system users who are service providers, list of task management system users who are customers of said user. The User Profile, and optionally each to-do list task item stored in the User Calendar Database, may further contain solicitation for offer preferences such as preferred offer location, brand name, purchase price, rebate, volume discount, environmentally green product, delivery, and consent to aggregation of said user's offer preferences data with other users within the task management system. The User Profile also includes linkable reference to the Rewards Database that provides information on user's rewards account.

For the purpose of this invention, the usage and definition of “mobile” extends to include users with devices that have mobile connectivity to the internet and/or intranet. Examples of such devices may include but are not limited to mobile phones, GPS enabled devices, music players, video players, electronic book readers, and other internet or network enabled devices.

The Rewards Database may be automatically or manually viewed, updated or modified by third party providers or the task management system (FIG. 1, FIG. 4, and FIG. 5. Users or authorized third party providers can view, listen, create, update or modify to-do list task items within the User Calendar Database using an input terminal through a plurality of means such as a widget application, logging on to the task management system, emails to said task management system, and other means, such as a touch tone phone, mobile phone, mobile terminal, SMS, voice, voice mail, electronic mail, instant messaging, widget application, software application, Automatic Programming Interface (API), or automated voice announcement software or voice recognition software. Periodic data feeds from the task management system consisting of user to-do list task items within the User Calendar Database can notify third party providers of changes to a user's to-do list task items and, thereafter, third party providers can employ either an automatic or manual solution to populate the Offer Database with linkable solicitation for offers for association with a user's to-do list task item within the User Calendar Database, as allowed by each User Profile. The task management system sets record pointers or links within the User Calendar Database to the Rewards Database information which the third party provider intended to associate with the User Calendar Database for the purposes of providing relevant solicitation for offers. The task management system may connect and receive information and content from a centralized Offer Database (the “Offer Database”) that contains then current solicitations for offer for incorporation into a users to-do list task item in the User Calendar Database, if the user so desires, including action details, due dates, and the number of reward points and/or other criteria related to the Offer (FIG. 13). Such action provides the user of the task management system the option to avail solicitation for offers that are not linked to any current user to-do list task item in the User Calendar Database but, if the user so desires, the user may select the solicitation for offer and create a new user to-do list task item consisting of a link to the user selected solicitation for offer within the Offer Database.

Information and content contained within the Rewards Database is delivered to user in multiple ways. Said information and content is electronically inserted, either in its entirety or by a linking means, within the user to-do list task item found in the User Calendar Database thereby allowing the relevant information and content to coexist, or linkable, within a user to-do list task item and accessible by the user as determined in the User Profile (see generally FIG. 2). The information and content may also be included in a user defined time interval, such as minutes, hours, days, weeks, month or such other calendared period, to-do task list item reminders which may populate as a calendared item on the user to-do list task item within the User Calendar Database or delivered to the user based on user profile. In addition to the information and content provided by third party providers, as delivered by the task management system, a user of the present invention may also proactively and selectively request offers, advertisements, solicitations, assistance, information and content from third party providers through the creation of a to-do list task item within the User Calendar Database; thereafter, such requests further refined and performed in accordance with the User Profile and the task management system.

The task management system will employ universal identifier/tag that is unique to the user and/or to his or her to-do list task items contained within the User Calendar Database. The universal identifier serves as the “Contact Information Depository Of Record” or “CIDOR ID”. The CIDOR ID is established through a unique acronym selected by the user and stored in the task management system. The user can provide this unique identifier to anyone he/she wishes to remind them about, but not limited to, events, tasks, appointments, promotions, action items, to-do items, etc. The unique identifier need not be numeric or alphabetic, but can be a combination or numbers, words or symbols or image. Upon registration in the task management system, a user is provided his or her unique CIDOR ID that becomes the universal identifier for the user and is technology and device agnostic. The CIDOR ID is provided (FIG. 2) to the user when they sign in/register with the task management system using an input device and is linked with the user's to-do list task items contained within User Calendar Database. If the user provides third party providers with the CIDOR ID, then the receiving third party provider can create within the User Calendar Database to-do list task items which are linkable to third party provider solicitation for offers contained with the Offer Database The CIDOR ID further serves as a universal switch that can automatically route information and content as determined by User Profile setting and can be used in conjunction with the tracking engine and third party provider systems to verify task completion and reward criteria completion.

The task management system allows for third party providers and other users of the task management system to provide rewards criteria in association with the linkable solicitation for offers contained with the Offer Database. Rewards criteria may consist of rewards points, coupons, incentives, awards and other means of recognition and reward.

An embodiment of this invention is the capability of users and or third party providers to create “group task” items by creating common to-do list task items across multiple users. By way of an example, but not a limitation, users who belong to a charitable group (e.g. March of Dimes) may establish a group, create a group to-do list task item (e.g. participate in the 10 K run on Jun. 10, 2011) and propagate the group to-do list task item with the associated reward criteria, to other members of the group that are users of the task management system. In the above example, without limitation, this could be accomplished by a single group user, a group administrator user, or the charitable group user of the task management system.

While the invention has been described with respect to particular illustrated embodiment, those skilled in the art and technology to which the invention pertains will have no difficulty devising variations which in no way depart from the invention. Accordingly, the present invention is not limited to the specific embodiments described above, but rather as defined by the scope of the appended claims and their equivalents.

### BRIEF DESCRIPTION OF THE DRAWINGS

For a more complete understanding, attached are drawings which show the system and method in various configurations.

FIG. 1 Task Management System and the various databases—internal or external (claim 1).

FIG. 2 Creation of the unique user identifier and user acronym (claims 2 and 4)

FIG. 3 Content Database (claim 5)

FIG. 4 Rewards system with the User calendar database (claims 6 and 7)

FIG. 5 Rewards system with the User calendar database and tracking engine (claim 9)

FIG. 6 Tracking engine for to-do list task items

FIG. 7 Illustration of user earning reward points

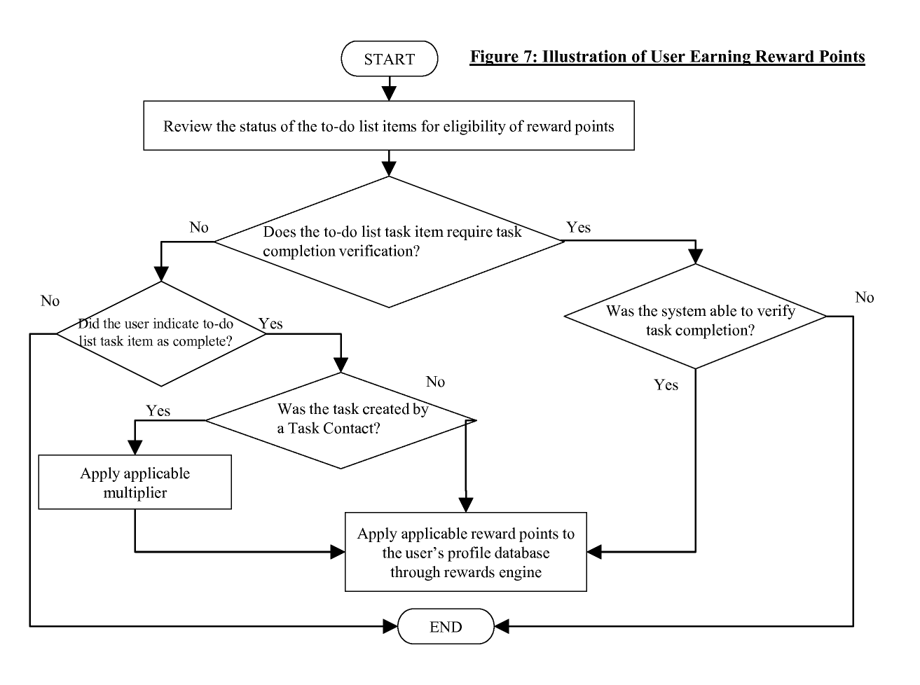

FIG. 8 User accepting a solicitation for offer and system creating a to-do task list item (claim 18)

FIG. 9 User selecting linkable object offer (claim 18)

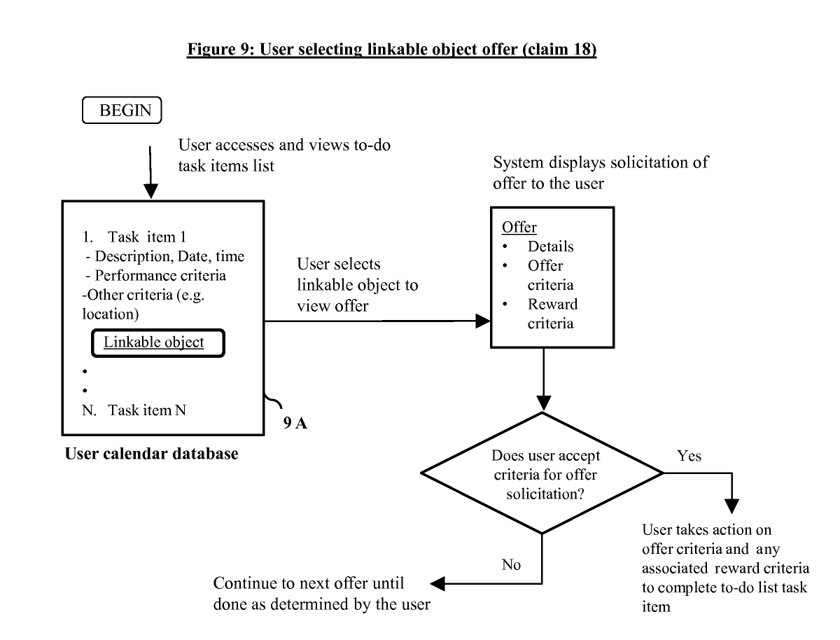

### DETAILED DESCRIPTION OF THE INVENTION

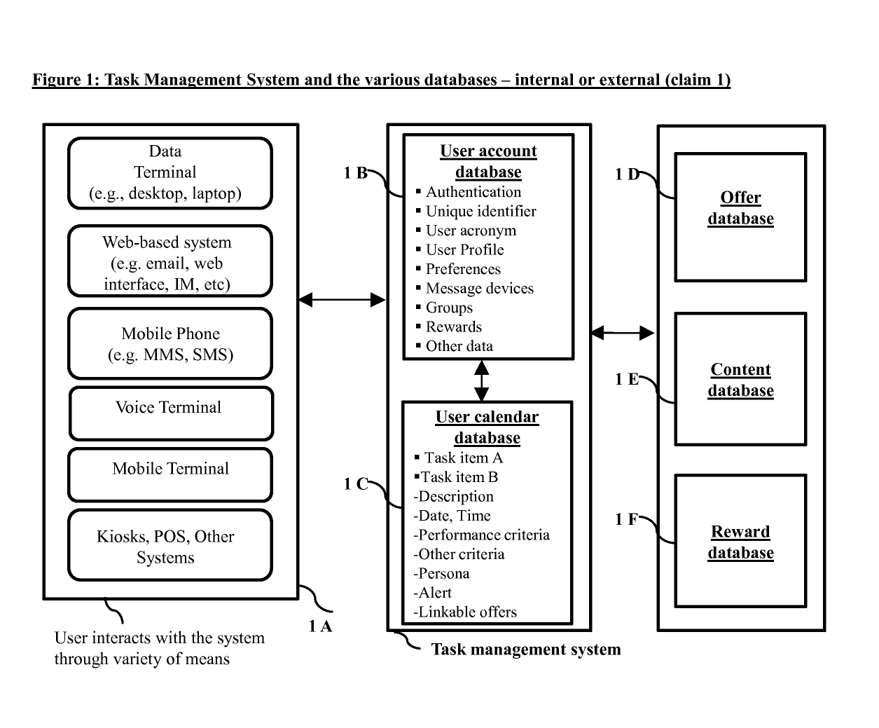

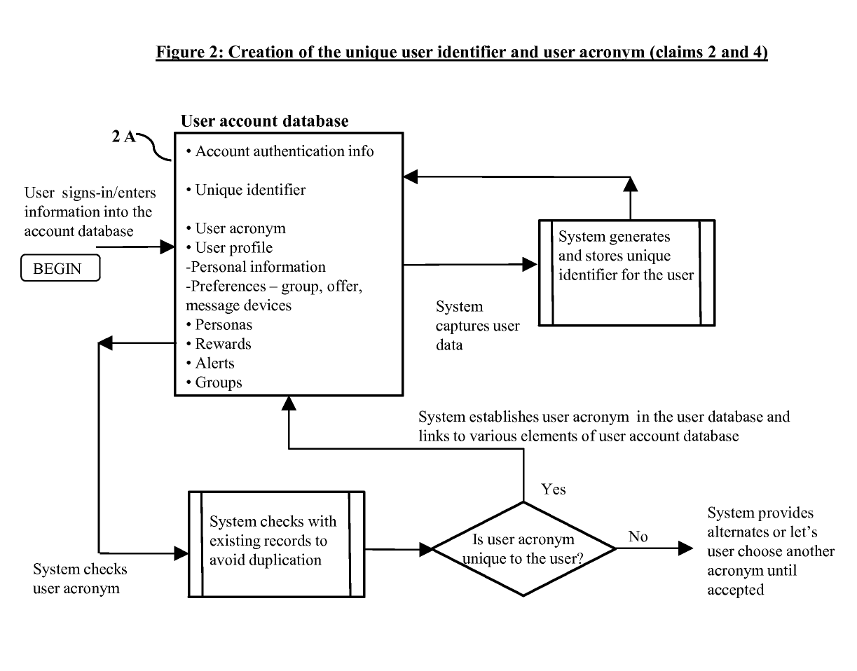

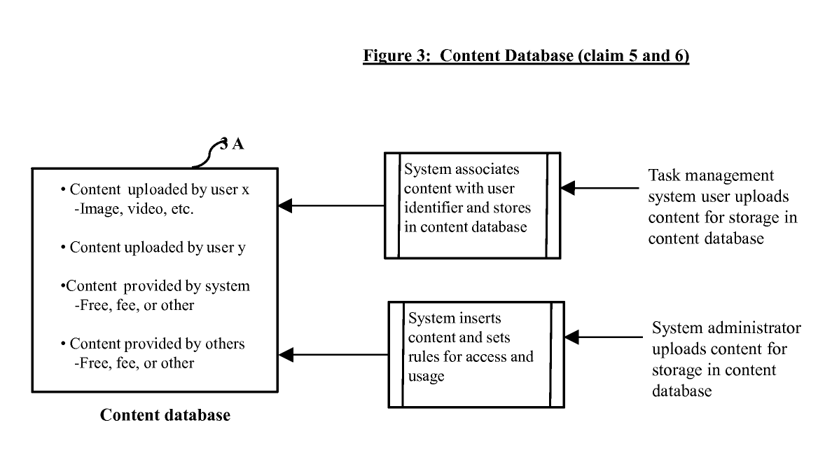

Generally, the present invention provides for a system and method for managing to-do list tasks items that utilizes a User Calendar Database, User Account Database, an Offer Database, Content Database, and a Reward Database. FIG. 1 shows that the User Account Database stores various user provided information, and the User Calendar Database stores the specific information and any associated criteria relating to a to-do list task item. A user, or third party provider, creates a to-do list task item within the User Calendar Database. A third party provider is only allowed to add, review and/or modify a to-do list task item of a user in accordance with such user authorization in the User Account Database, such third party provider then capable of allocating rewards from a Reward Database to user for completing such to-do list task item. FIG. 1 further shows a means of inputting data (FIG. 1A) into the User Account Database and User Calendar Database for creation of User Profiles and to-do list task items, respectively. The task management system creates a unique identifier within the User Account Database (FIG. 2A) which can be used to track and maintain to-do list task items, any third party solicitation for offers and to track and verify to-do list task item completion for rewards. The Content Database (FIG. 3) operates as a repository of digital media uploaded and stored either by the user, a third party provider, or the task management system administrator, as more fully described in the specification. The task management system requires a user computing device (terminal) capable of accessing a network connected to a server running the task management system, such task management system hosting and processing through a processing device the User Account Database, User Calendar Database, Offer Database, Content Database, and Reward Database, such database stored on a computer storage device and such task management system operated by a central processing unit.

After the user has created a user account, defined user preferences within the User Account Database, and has been assigned a unique identifier (CIDOR), the user can then create a to-do list task item.

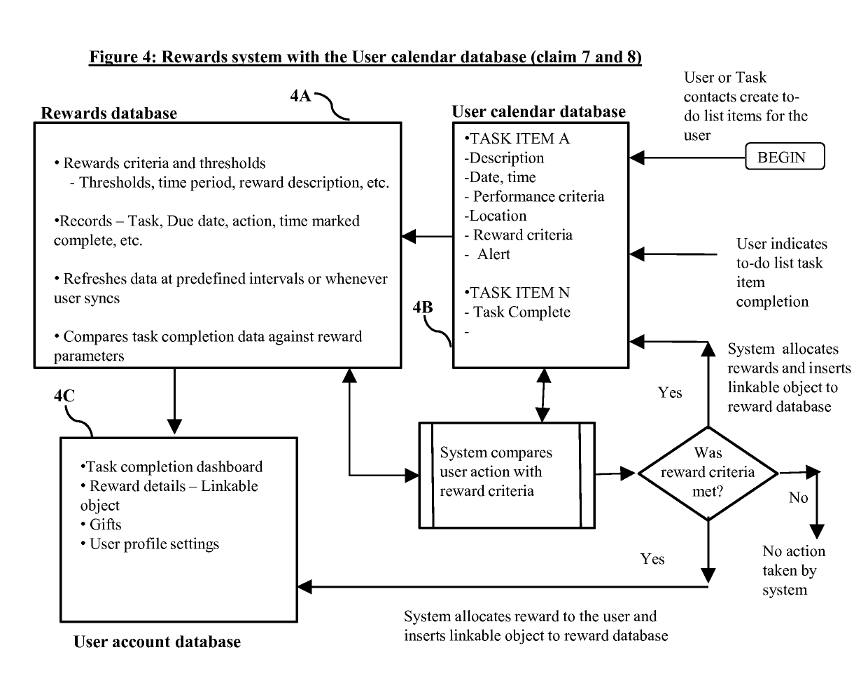

In an embodiment of the present invention, FIG. 4 shows where user can create a to-do list task item or accept for inclusion a to-do list task item created by another user of the task management system and assigned to the said user. The to-do list task item will have an associated reward criteria determined by the system and referentially linked to the rewards database. Upon indication by the user to the system that the to-do list task item has been accomplished or completed, without verification of actual completion, the system checks if the reward criteria has been met and allocates rewards to the user in the rewards database and inserts linkable object, connecting to the rewards database, in the user's account database and user's calendar database.

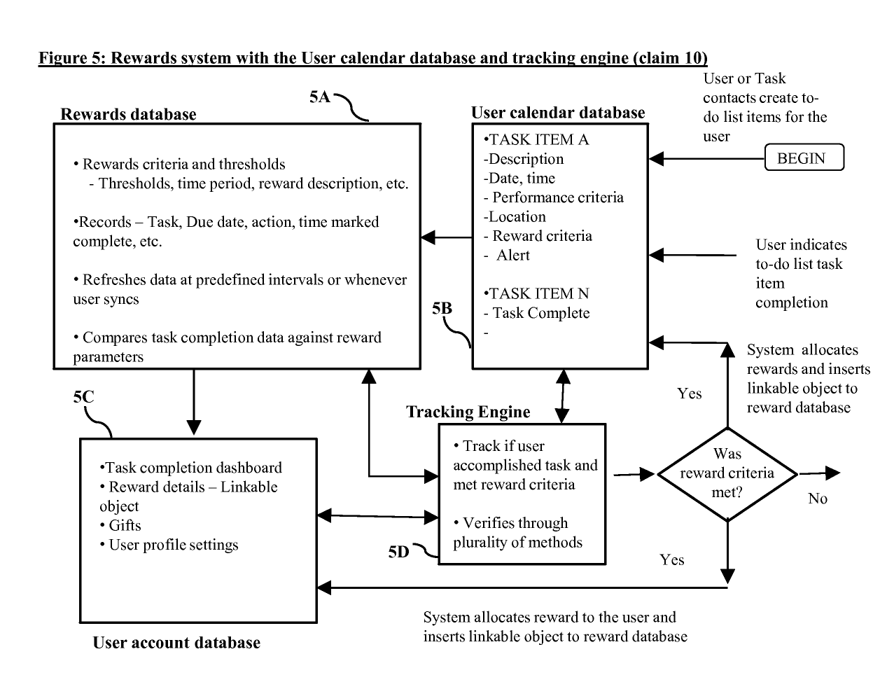

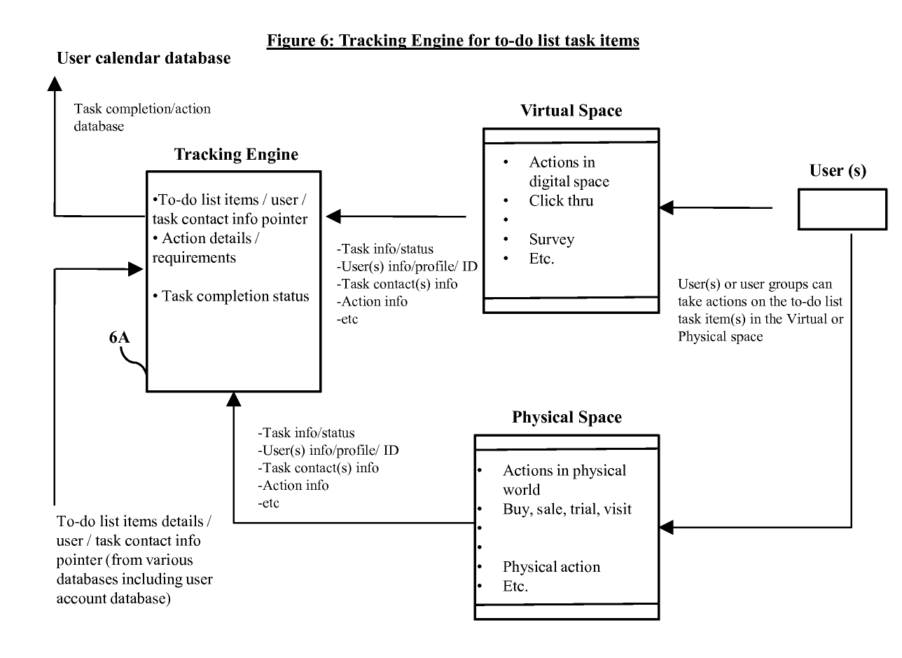

In another embodiment of the present invention, FIG. 5 shows where user can create a to-do list task item or accept for inclusion a to-do list task item created by another user of the task management system and assigned to the said user. The to-do list task item will have an associated reward criteria determined by the system and referentially linked to the rewards database. Upon indication by the user to the system or by other automatic means of tracking (FIG. 5 and FIG. 6), that the to-do list task item has been accomplished or completed, with verification of actual completion through a tracking engine (FIG. 5 and FIG. 6), the system checks if the reward criteria has been met and allocates rewards to the user in the rewards database and inserts linkable object, connecting to the rewards database, in the user's account database and user's calendar database.

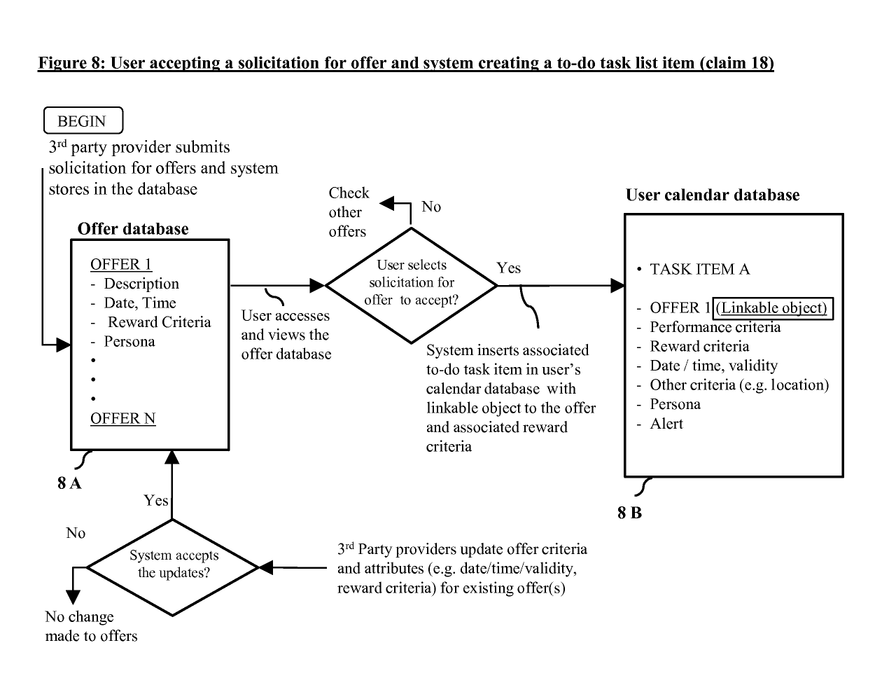

In another embodiment, a user may periodically review third party provider solicitations for offer contained within the Offer Database (FIG. 8A), and upon selection, the system will display such third party solicitations for offer to the user for acceptance. These offers contain without limitation, tasks that a third party provider wants the user to accomplish and includes associated reward criteria for task completion. If the user accepts the solicitations for offer, then the task management system inserts and stores a new to-do list task item within the User Calendar Database and associates a linkable object to the accepted solicitations for offer within the Offer Database to such new to-do list task item. (FIG. 8 B). Importantly, third party providers may periodically update the linkable object now associated with such to-do list task item and, upon acceptance by the task management system of such an update, the task management system updates the linkable object for associated with such to-do list task item within the User Calendar Database. Thereafter, and upon selection as shown in FIG. 8, the user may either accept the solicitation for offer, or decline the solicitation for offer upon viewing the offer criteria and related reward criteria. If the offer is accepted, then the user can take action on the task(s) associated with such offer; otherwise, the user can ignore the offer and choose not to interact with the offer at that time. Upon notification that a user has taken action on the task and met the reward criteria associated with such offer, the reward is transferred within the Reward Database to user.

In another embodiment, user of the task management system can create a group to-do list task item. Group task users must have identified themselves in the User Account Database as group task users (FIG. 15C) and may have common virtual group persona selected from the Content Database (FIG. 15D). If a group task user has authorized the task management system to provide group access to calendaring and to-do list task item management, then the task management system will display (FIG. 15D) the created group to-do list task item to relevant group users and, if acceptable by such relevant group users, the task management system inserts and stores a new to-do list task item in each relevant group users to-do list task item Calendar Database.

While the above description is of the preferred embodiment of the present invention, it should be appreciated that the invention may be modified, altered, or varied without deviating from the scope and fair meaning of the following claims.

What is claimed:

1. A method implemented on a server for managing individual and group to-do-list task items in a task management system, comprising: said server connected to the Internet, said server maintaining a user account database for users of the task management system; said server maintaining a user calendar database for users of the task management system; said server communicating with an offer database for users of the task management system; said server communicating with a content database for users of the task management system; and said server communicating with a reward database for users of the task management; said server communicating with a tracking engine; said server connected to a network and facilitating the creation, calendaring and maintenance of individual and group to-do-list task items by users within a web hosted task management system, such task management system accessible by a plethora of users via a client browser and permitting said users, if said users are authorized, to modify at least one of said individual and group to-do-list task items within said task management system.

2. The method of claim 1, wherein the user account database includes account authentication information, a user unique identifier; a user acronym selected from a group consisting of a user provided identification, a user e-mail address, and a user phone number, such user acronym associated with said unique identifier; a user selected virtual personal persona; a user selected virtual group persona; a user selected virtual to-do-list task item task persona, a user selected hierarchy of group preferences, a user selected hierarchy of offer preferences, a user selected hierarchy of message devices, and a user defined alert for to-do-list task item task message reminders, user reward details and history with links to the rewards database, and user personal profile information within said to-do-list task item task management system.

3. The method of claim 1, wherein the offer database includes at least one solicitation for an offer from: third party providers of services, third party providers of products, and other users of said task management system, each solicitation for an offer containing a reward criteria of at least one of the following: digital media, points, coupons, and message information, such reward criteria referentially stored within said reward database.

4. The method of claim 3, wherein said account authentication information includes a user id and a password; said unique identifier is randomly generated by said to-do-list task item task management system; said message devices includes at least one physical mailing information, telephone information, instant messaging information, e-mail information, pager information, terminal information, and mobile terminal information; said personal profile information includes said user's name and e-mail address; said group preferences includes at least one list of task management system users who are familial to said user, list of task management system users who are within said user's social network, list of task management system users who are non-profit business entities, list of task management system users who are service providers, and list of task management system users who are customers of said user; said offer preferences consist of at least one of the following an offer location preference, brand name preference, purchase price preference, rebate preference, volume discount preference, environmentally green product preference, delivery preference, and consent to aggregation of said user's offer preferences data with other users of said task management system.

5. The method of claim 4, wherein said content database includes at least one of the following: said user's uploaded digital media; free user preloaded digital media uploaded by other task management system users, fee-base licensable preloaded digital media uploaded by task management system users, free preloaded digital media by the task management system administrator, or fee-base licensable preloaded digital media by the task management system administrator. The said content database is also a content marketplace for users of the task management system to buy, sell and trade digital media.

6. The method of claim 4, further comprising steps wherein said user creates a to-do-list task item which includes at least one description, date, time, performance location, virtual to-do-list task item task persona, a to-do-list task item alert, and said to-do-list task items are stored in the user calendar database, and accessible by at least one of the following: other task management systems users, and said task management system administrator.

7. The method of claim 6 wherein the task management system associates reward criteria with a user created to-do list task item. Wherein the system links the to-do list task item with the associated reward criteria stored in the reward database. Such criteria, as set by the task management system, to include at least one a) to-do list task items threshold; a minimum set, greater than or equal to one, of user to-do list task items, b) time period between which the reward criteria needs to be met, and required user action and a reward description and a reward multiplication factor, greater than or equal to one, as defined by the system.

8. The method of claim 7 wherein the system required user action requires the user to interact with the task management system to indicate to-do list task item completion, such an indication not requiring verification of the said to-do list task item completion.

9. The method of claim 7 wherein the system required action requires the user or a tracking engine to interact with the task management system to indicate to-do list task item completion, such an indication requiring verification of the said to-do list task item completion through a tracking engine. Wherein such tracking engine includes methods, processes, data systems, APIs, and other data access and/or input means that aid in verification of completion of the said to-do list task item and associated reward criteria.

10. The methods of claims 8 and 9 wherein the system allocates reward, in accordance with the reward criteria, to the said user in the rewards database and inserts a linkable object to said reward in the said user's to-do list task item and said user's account database.

11. The method of claim 6, further comprising steps wherein a user of the task management system creates to-do-list task items and wherein said user further assigns the said to-do-list task items to another user or a group of users of the task management system.

12. The method of claim 11, further comprising steps wherein said user authorizes the task management system to make said to-do-list task items available to another user or group of users for inclusion on said users calendars.

13. The method of claim 12, wherein the task management system or a user other than the said user associates reward criteria with said assigned to-do list task items and links the to-do list task item with the associated reward criteria stored in the reward database. Such criteria, to include at least one a) to-do list task items threshold; a minimum set, greater than or equal to one, of user to-do list task items, b) time period between which the reward criteria needs to be met, c) group users threshold; a minimum set, greater than or equal to one, of group users, and required user action and a reward description and a tracking mechanism and a reward multiplication factor, greater than or equal to one, as defined by the system.

14. The method of claim 13 wherein the system required user action requires the user to interact with the task management system to indicate to-do list task item completion, such an indication not requiring verification of the said to-do list task item completion.

15. The method of claim 13 wherein the system required action requires the user or the tracking engine to interact with the task management system to indicate to-do list task item completion, such an indication requiring verification of the said to-do list task item completion through a tracking engine. Wherein such tracking engine includes methods, processes, data systems, APIs, and other data access and/or input means that aid in verification of completion of the said to-do list task item and associated reward criteria.

16. The method of claim 3, wherein a third party provider includes a to-do list task item with an associated reward criteria as an offer in the offer database. Such reward criteria containing at least one of the following: digital media, points, coupons, and message information, such reward criteria referentially stored within said reward database.

17. The method of claim 16, wherein the task management system or a user other than the said user associates reward criteria with said assigned to-do list task items and links the to-do list task item with the associated reward criteria stored in the reward database. Such criteria, to include at least one a) to-do list task items threshold; a minimum set, greater than or equal to one, of user to-do list task items, b) time period between which the reward criteria needs to be met, c) group users threshold; a minimum set, greater than or equal to one, of group users, and required user action and a reward description and a tracking mechanism and a reward multiplication factor, greater than or equal to one, as defined by the system.

18. The method of claim 17, wherein said users of the task management system can access the offer database for such third party provider to-do list task items for inclusion in the user's calendar as a to-do list task item.

19. The method of claim 18 wherein the third party provider required user action requires the user or the tracking engine to interact with the task management system to indicate to-do list task item completion, such an indication requiring verification of the said to-do list task item completion by the user or through a tracking engine. Wherein such tracking engine includes methods, processes, data systems, APIs, and other data access and/or input means that aid in verification of completion of the said to-do list task item and associated reward criteria.

20. A electronic to-do-list task item task management system implemented on a server for managing individual and group to-do-list task items in a task management system, comprising: said server connected to the Internet, a data storage device accessible by said server for storage and retrieval of database records, said server maintaining a user account database for users of the task management system; said server maintaining a user calendar database for users of the task management system; said server communicating with an offer database for users of the task management system; said server communicating with a content database for users of the task management system; and said server communicating with a reward database for users of the task management, said server communicating with a tracking engine, said server connected to a network, a program executing on said server for facilitating the creation, calendaring and maintenance of individual and group to-do-list task items by users within a web hosted task management system, such task management system accessible by a plethora of users via web enabled client browsers and permitting said users, if said users are authorized, to modify through an input means at least one of said individual and group to-do-list task items within said task management system, said program further capable of aggregating a plethora of user to-do-list task items for solicitation of offers.
